(19) United States
(12) Patent Application Publication
(10) Pub. No.: US 2014/0289826 A1
(43) Pub. Date: Sep. 25, 2014

(54) ESTABLISHING A COMMUNICATION SESSION

(71) Applicant: Martin Tyrrel Croome, Brié et Angonnes (FR)

(72) Inventor: Martin Tyrrel Croome, Brié et Angonnes (FR)

(73) Assignee: OPTION, Leuven (BE)

(21) Appl. No.: 14/356,317

(22) PCT Filed: Nov. 7, 2011
(86) PCT No.: PCT/EP2011/069574

§ 371 Date: May 5, 2014

(51) Int. Cl. H04L 29/06

(52) U.S. Cl. CPC H04L 63/08
USPC 726/5

(57) ABSTRACT

A secure communication session is established between a first endpoint and a second endpoint. The first endpoint can contact the second endpoint via a first communication network and via a second communication network. The first communication network is more trusted than the second communication network. The first endpoint determines that a secure communication session is required. A security association is established between the endpoints for the communication session on a connection via the first communication network. Service is received on a connection via the second communication network using the previously established security association. The step of establishing a security association can comprise authenticating the second endpoint and negotiating a shared secret and the step of receiving service on a connection via the second communication network can occur without any further negotiation of key material or authentication between the endpoints via the second communication network.

### FIELD OF THE INVENTION

This invention relates to a method, a system and a module, such as a peripheral device, for establishing a communication session between endpoints.

### BACKGROUND OF THE INVENTION

Wireless communication networks are used to provide connectivity to users of mobile communication devices. Many locations, such as cafés, hotels, transport hubs and homes provide unlicensed wireless access points (e.g. WiFi hotspots) which a user can use to access the Public Internet. Unlicensed wireless access points can provide high data rates within the limited area of the access point, and often have minimal, or no, service charge. Accordingly, such networks are often used in preference to other types of network, such as GPRS/3G/4G networks, which can impose very high service charges, especially when a user roams outside their home network territory.

A problem with unlicensed wireless hotspots is that they are usually deemed less secure than subscriber networks as they can be compromised by attackers in various ways. Such networks are often called untrusted networks.

One way of improving the security of a session over this type of untrusted network is to use protocols which authenticate and encrypt network connections such as Secure Sockets Layer/Transport Layer Security (SSL/TLS) or Internet Protocol Security (IPSEC). Connections to secure web sites can use SSL/TLS through the Hypertext Transfer Protocol Secure (HTTPS) protocol. HTTPS combines Hypertext Transfer Protocol (HTTP) with Secure Sockets Layer/Transport Layer Security(SSL/TLS). Both SSL/TLS and IPSEC create Security Associations (SA) between endpoints using authentication technologies such as digital certificates and key exchange systems for the negotiation of symmetric keys that are used to encrypt traffic. Creating a Security Association involves identification and authentication of the endpoints that wish to communicate and the secure exchange of necessary information such as shared secrets that can insure the confidentiality and security of the communication. HTTPS servers use a digital certificate to prove their identity through ownership of a specific DNS name. A public Certificate Authority (CA), whose root certificate is present in all generally used internet browsers/operating systems, issues a certificate that signs the DNS name of the site in the Common Name CN of the certificate. The CA is essentially certifying the ownership of a DNS record binding a specific IP address to a DNS name.

Certificate Authorities do not issue DNS addresses and cannot directly prove this association, so they use a variety of mechanisms (contacting the DNS record owner for example) to establish this proof. Given the very high volume of SSL certificates issued the systems to establish this proof are generally internet based and highly automated. This has led to them being relatively easy to compromise.

Browsers generally contain many root certificates. Just because one root certificate may have a strong issuance process does not mean that others present will. Unfortunately, from the user's perspective a site verified with one root CA's certificate is indistinguishable from another, as they all provide the user with the same visual indication (e.g. closed padlock symbol) in the browser.

Authentication, encryption and key exchange mechanisms used to create Security Associations between endpoints are continuously evolving as new threats and exploits are discovered. When these exploits are known by groups of attackers before being known by the protocol implementer they are called zero-day attacks.

The present invention seeks to provide a way of increasing security when a user wishes to use an insecure or untrusted network.

### SUMMARY OF THE INVENTION

An aspect of the invention provides a method of establishing a secure communication session between a first endpoint and a second endpoint, wherein the first endpoint can contact the second endpoint via a first communication network and via a second communication network, wherein the first communication network is more trusted than the second communication network, the method comprising, at the first endpoint: determining that a secure communication session is required; establishing a security association between the endpoints for the communication session on a connection via the first communication network; and receiving service on a connection via the second communication network using the previously established security association.

An advantage of the method is that the step of creating a Security Association is carried out via the first network, which is deemed to be more trusted, or secure, than the second network.

The term “trust” refers to the level of trust that can be attributed to the security of the network. This can also be defined as the degree to which the networks can be considered secure from third party attacks. A network such as a GPRS/3G/4G wireless network is considered to have a higher level of trust than an unlicensed wireless access point particularly when used with a private Access Point Name (APN) that provides a direct connection to a destination network. Similarly, a mobile radio system provided for public bodies such as Terrestrial Trunked Radio (TETRA) is considered to have a higher level of trust than an unlicensed wireless access point.

A communication network offering a high level of trust is often more expensive and/or offers lower throughput than a communication network offering a lower level of trust. An advantage of the method is that only the most vulnerable part of the session is performed over the first, more trusted, communication network while the remainder is performed over the second, less trusted communication network. This can provide the user with a better quality of service and/or reduced cost.

The first network can be a subscriber network, such as a GPRS/3G/4G network which the user of the communication device requires a service subscription to use. Furthermore the first network could, using the facilities available in subscriber networks, use a direct connection between an operator's network and the destination network which completely bypasses the public internet. This is known as a private Access Point Name (APN). The second network can comprise an untrusted network such as an unlicensed wireless access point connecting to the public Internet. Generally, the second network is a network which does not require trusted user authentication and provides a direct connection to the public internet and is therefore more easily compromised.

Advantageously, the first endpoint (client) is authenticated, but this is optional. Authentication of the first endpoint (device) may occur as part of the initial step of establishing a security association, or may occur later optionally as part of the authentication to a specific service or application.

The step of creating a security association can comprise authentication of the server-side endpoint and key material negotiation. Optionally, it can comprise authentication of the client device. The authentication of the server, and any other protocols used during establishment of the session, are less likely to be compromised by a communication path using the first network. Advantageously, service is received over the second network without the need to authenticate an endpoint (or endpoints), agree ciphers and protocols for key exchange and encryption or establish shared key material since this was already established in the security association over the first, more trusted, network.

Another advantage of the method is that the endpoint of the connection can reject attempts to create sessions on the second network unless a previously established Security Association exists. This protects the destination endpoint from attack from the public network.

Another advantage of the method is that it provides protection against zero-day attacks because it makes interception and analysis of the traffic between two endpoints more difficult for the attacker.

Another aspect of the invention provides a method of establishing a secure communication session between a first endpoint and a second endpoint, wherein the first endpoint can contact the second endpoint via a first communication network and via a second communication network, wherein the first communication network is more trusted than the second communication network, the method comprising, at the second endpoint: receiving a request to establish a security association between the endpoints for the communication session; establishing the security association between the endpoints for the communication session on a connection via the first communication network; and providing service on a connection via the second communication network using the previously established security association.

Another aspect of the invention provides a module such as a peripheral device suitable for connection to a host computer device and for establishing a secure communication session between the host computer device and an endpoint, wherein the host computer device can contact the endpoint via a first communication network and via a second communication network, wherein the first communication network is more trusted than the second communication network, the module comprising: a memory; computer executable code stored in the memory comprising: a code portion for determining that a secure communication session is required; a code portion for establishing a security association between the host computer device and the endpoint for the communication session on a connection via the first communication network; and a code portion for receiving service on a connection via the second communication network using the previously established security association.

The module can be provided as a peripheral device which connects to the host device, such as in the form of a peripheral device which connects to the host via an interface such as USB, or in the form of a peripheral device such as a router which connects to the host computer device using a wired or wireless interface. The peripheral device may mechanically plug into the host device. The peripheral device may be a plug and play device. Alternatively, the module can be provided as an embedded module within the host device, such as in the form of a circuit board or an integrated circuit. One or more or all of the code portions may refer to portable applications. One or more or all of the code portions may refer to zero footprint applications.

Advantageously, the module such as a peripheral device further comprises at least one of: a first communication interface for accessing the first network; a second communication interface for accessing the second network.

Advantageously, the code portions may be stored in encrypted or read only memory that protects the code portions from modification.

Advantageously, the module such as a peripheral device comprises: a first communication interface for accessing the first network; a processor; and wherein the processor is arranged to execute the code portion for establishing a security association between the host computer device and the endpoint for the communication session on a connection via the first communication network. This arrangement has an advantage that it minimises leakage of information necessary to establish the session outside of the module.

Advantageously, the module such as a peripheral device stores at least one application and is provided for launching the application as a portable application. This has an advantage that the portable application keeps its data (cache) in the memory of the module and no traces are left on the host computer device, i.e. it leaves a zero footprint on exit or closing. Advantageously, the application is a world wide web browser.

In any of the aspects, the communication session can be one of: a Secure Sockets Layer/Transport Layer Security (SSL/TLS) session; and an Internet Protocol Security (IPSEC) session. Other security protocols can be used to establish a security association.

The functionality described here can be implemented in hardware, software executed by a processing apparatus, or by a combination of hardware and software. The processing apparatus can comprise a computer, a processor, a state machine, a logic array or any other suitable processing apparatus. The processing apparatus can be a general-purpose processor which executes software to cause the general-purpose processor to perform the required tasks, or the processing apparatus can be dedicated to perform the required functions. Another aspect of the invention provides machine-readable instructions (software) which, when executed by a processor, perform any of the described methods. The machine-readable instructions may be stored on an electronic memory device, hard disk, optical disk or other machine-readable storage medium. The machine-readable instructions can be downloaded to the storage medium via a network connection.

### BRIEF DESCRIPTION OF THE DRAWINGS

Embodiments of the invention will be described, by way of example only, with reference to the accompanying drawings in which:

FIG. 1 shows a communication system according to an embodiment of the invention with a first (trusted) network and a second (untrusted) network;

FIG. 2 shows an overview of a method to establish a session via the second (untrusted) network;

FIG. 3 shows signalling for establishing an HTTPS session;

FIG. 4 shows signalling for resuming an HTTPS session;

FIGS. 5A and 5B show steps of a method performed by a client communication device;

FIGS. 6A-6C show steps of a method performed by a server;

FIG. 7 shows an embodiment of apparatus at a client communication device;

FIG. 8 shows more detail of the apparatus of FIG. 7;

FIG. 9 shows another embodiment of apparatus at a client communication device.

### DETAILED DESCRIPTION OF AN EMBODIMENT

In the following detailed description of the preferred embodiments, reference is made to the accompanying drawings, which form a part hereof, and within which are shown by way of illustration specific embodiments by which the invention may be practiced. The drawings described are only schematic and are non-limiting. In the drawings, the size of some of the elements may be exaggerated and not drawn on scale for illustrative purposes. Those skilled in the art will recognize that other embodiments may be utilized and structural changes may be made without departing from the scope of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

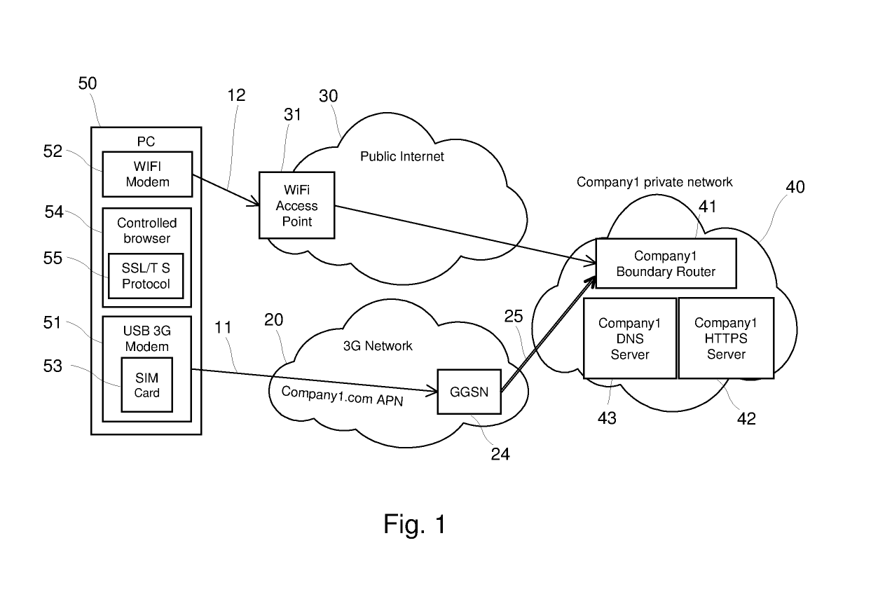

FIG. 1 shows an example communication system in which an embodiment of the invention can be applied. FIG. 1 shows a client communication device 50, a first communication network 20 (in this example a 3G wireless network), a second communication network 30 (in this example the Public Internet, which is accessed via an unlicensed public WiFi access point 31) and a network 40 (in this example, a corporate network belonging to Company1). The client communication device 50 can be any suitable processing device such as a personal computer, a smart phone, a laptop, a security camera, a network router, a machine-to-machine terminal or any stationary or portable communication device which is capable of accessing the first network 20 and the second network 30. To access the first network, the client communication device 50 has a first communication interface 51. In FIG. 1, the communication device 50 has a first communication interface configured as a modem device. The modem can be, for example, a wireless modem device. As used herein, with “wireless modem device” or “wireless modem” can be a computer peripheral device which has an electronic interface for connection to a complementary electronic interface of a computer device (host) and which comprises electronic components for establishing communication between said computer device to which it is connected and a remote device over a wireless communication network. The electronic interface can for example be a USB interface, a firewire interface, a PCI express interface, a PCMCIA interface or any other electronic interface known to the person skilled in the art. The wireless communication network can be WLAN, GSM, GPRS, UMTS, EDGE, HSUPA, HSDPA, 3G, 3.5G, 4G or any other wireless communication network known to the person skilled in the art. In preferred embodiments, the wireless modem device of the invention can have electronic components for communicating over two or more different wireless communication networks. The wireless modem 51 can have a Subscriber Identity Module (SIM) 53 which stores information that identifies the subscriber. The modem or wireless modem such as the 3G modem 51 can be provided in any suitable form. In embodiments of the present invention it can be in the form of a peripheral device which connects to the host device 50 via an interface such as a plug and play interface. One example of such an interface is a Universal Serial Bus (USB) interface. In embodiments of the present invention the modem or the wireless modem can be provided as a module within client communication device 50. The client communication device 50 also has a second communication interface 52 such as a second wireless interface. The second wireless interface can be configured as a WiFi modem 52 for accessing the WiFi network, for example.

In FIG. 1, Company1 has purchased a leased line 25 from their mobile network operator 20 that is connected to the company's private network 40 via the Gateway GPRS Support Node (GGSN) 24 of the mobile network operator 20.

An Access Point Name (APN) identifies an IP network that a GPRS/3G modem 51 wishes to connect to. Many mobile network operators (MNO) define an APN for public internet access and one or more APNs for restricted access to internal systems (portals and such like). Physically and logically the APN determines the route that IP traffic will take as it exits the GGSN (Gateway GPRS Support Node 2G/3G)/PGW (PDN Gateway 4G) to a network outside the MNO's systems. Some MNOs offer private APNs which allow routing to private IP networks either via leased lines, hosting of systems at MNO controlled data centres or by VPN tunnels from the MNO network to the remote private network.

This arrangement means that the communication device 50 has a direct connection to a known system 40, if it is assumed that the MNO's internal data network 20 is secure. This means that a specific security configuration can be enabled on this link versus the normal public internet link on the destination network. It also means that IP support systems such as DNS 43 can be hosted on the private network 40 that the APN connects to. The SIM card 53 can store credentials allowing access to the private APN (company1.com).

The SSL/TLS or IPSEC protocol stack is typically provided as part of browser software, but does not have to be provided as part of browser software. Any software or hardware module which uses one of these protocols, or another protocol, to establish a secure communications session could be used. For example, the SSL/TLS or IPSEC protocol stack can form part of a module for accessing a Virtual Private Network (VPN). Details of protocol stacks is provide later.

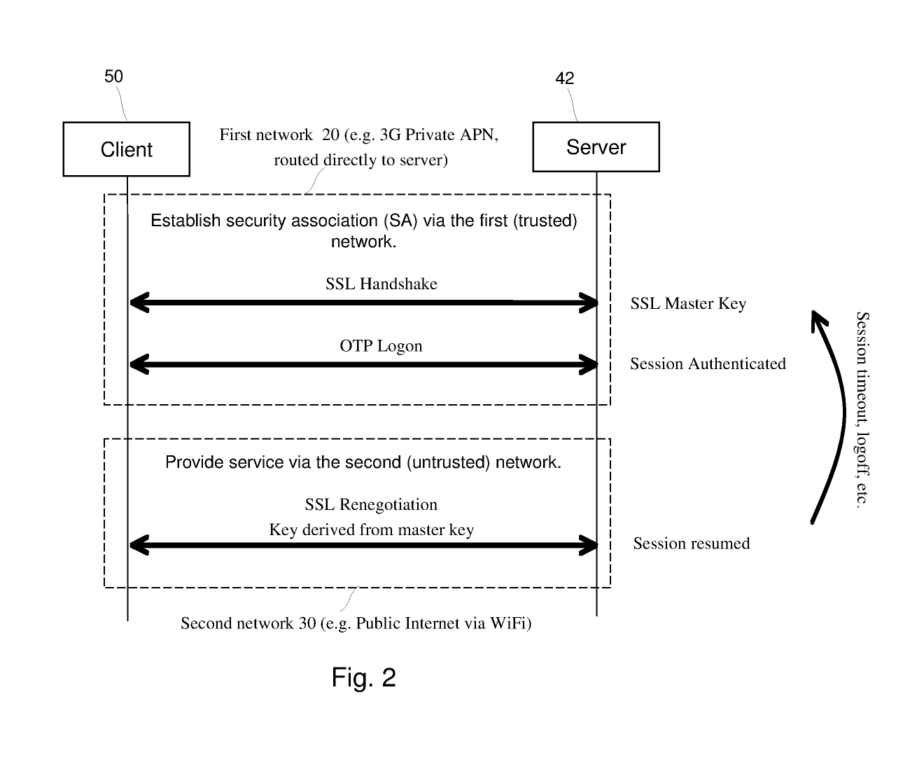

An overview of the method will be described with reference to FIGS. 1 and 2. If a user wishes to connect via the second (untrusted) network 30, the first modem, e.g. the 3G modem 51 first establishes a session via the first (trusted) network 20. The 3G modem 51 establishes a connection to the company1 private APN using credentials stored in the SIM card 53. SIM card 53 can also store a username and password assigned by the mobile network operator. A user of device 50 can use the controlled browser 54 to establish a connection to the company1 Hypertext Transfer Protocol Secure (HTTPS) server 42. The controlled browser may be present on the device 50 or loaded from memory in the 3G modem. The controlled browser will initiate an HTTPS connection to the server 42. Initially, this will be forced by the controlled browser to occur over the 3G connection 11 to the private APN. The device's IP/SSL/TLS stack will query the company's DNS server 43 for the address of the company's HTTPS server 42. It will then execute a normal SSL/TLS handshake with Company1's HTTPS server 42. This authenticates the HTTPS server 42 to the communications device 50 and may also authenticate the communications device 50 to the HTTPS server 42 and then negotiates a shared master secret which is associated with the session between the two systems. The session is identified at both endpoints by a shared, but not secret session ID. This step forms a Security Association between the HTTPS server 42 and the communications device 50. If successful, then the 3G modem 51 will force the controlled IP/SSL/TLS stack to terminate this connection and perform a SSL/TLS session resumption using the existing Security Association using the second modem, e.g. the WIFI modem 52 and a connection 12 to the public internet 30. The public internet 30 is also connected to the company1 private network 40. This resumption of the SSL/TLS session uses the previously established session ID, agreed encryption algorithm and keys derived from the shared master secret. No authentication is carried out during resumption since the endpoints can only communicate if they able to decrypt and encrypt data correctly. The advantages of this arrangement with respect to possible attacks will now be described. Firstly, consider that an attacker is in control of the WiFi access point 31 by which the client device 50 access the public Internet 30. In this situation, it is possible that the attacker will be able to insert an intermediary server into the dialog between the client device 50 and the HTTPS server 42. However, the attack will not succeed because the attacker was not party to the Security Association and therefore is not in possession of the shared master key and does not have knowledge of the encryption algorithm decided, which is only established over the 3G connection 11. Therefore, the attacker will only see a stream of traffic that uses an unknown encryption algorithm with unknown keys and will have significantly less chance of being able to decrypt or tamper with it. The attacker would have needed to simultaneously insert themselves into the dialog with the server 42 over the 3G connection 11 and the dialog with the server 42 over the public internet connection 12 to carry out an attack on the Security Association protocol and subsequent communications.

The attacker may try to connect directly over the public internet 20 to the company1 HTTP server. However, they must be in possession of the 3G USB modem 51 since an attempt to initiate an SSL/TLS connection over the public internet can be rejected by the HTTPS server 42 or by the boundary router 41. Only connections using SSL/TLS resumption of a valid session already establish with the HTTPS server are accepted from the public internet 30. This demonstrates the benefit of forming a Security Association over a separate private network. Furthermore, as the SSL/TLS session initiation handshake is forced to be established over the 3G private APN, any zero day exploit found in the SSL/TLS handshake, particularly in the certificate verification or master key exchange will be difficult to exploit since the hacker must be able to compromise the mobile network operator 20 or company1 network 40.

The method described above of SSL/TLS session forcing exploits the use of dual routes to an SSL server 42: one route via a controlled/trusted network 20 that provides a higher level of assurance of the correct routing of packets and one via a potentially untrusted network 30. It forces the use of the controlled network link 11 to initiate the SSL/TLS connection and then forces a switch to a faster but less secure secondary network link 12 and initiates a session resumption on this network. This can avoid threats of man-in-the-middle attacks on the untrusted network 30 because the session resumption protocol relies solely on the previously negotiated master key for both authentication and encryption, and does not require a further key exchange material to be sent via the untrusted network 30.

The server 42 or boundary router 41 can be configured to reject any session establishment via the untrusted network 30. This requires a client device 50 to present valid credentials and also to have access to the trusted network 20, thereby adding an extra factor in providing access to the target system.

Other security factors establish by the client device 50 connection to the trusted network such as its approximate location determined by the network and cell ID can be used during the initial authentication of the client device over the trusted network.

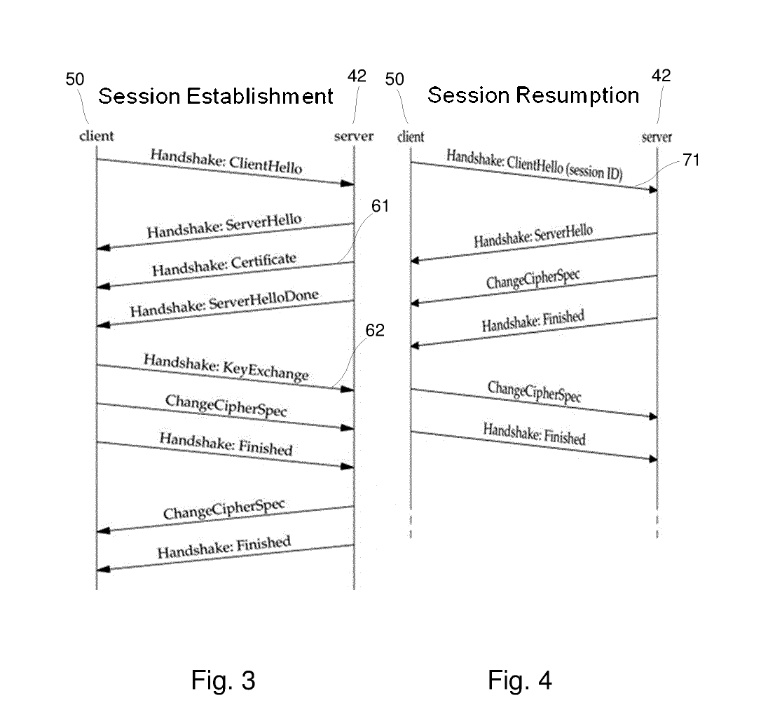

FIG. 3 shows, in more detail, signalling between a client device 50 and a server 42 to establish an SSL/TLS session. The server (but not the client) is authenticated by its certificate.

1. A client sends a ClientHello message specifying the highest TLS protocol version it supports, a random number, a list of suggested CipherSuites and suggested compression methods. If the client is attempting to perform a resumed handshake, it will send a session ID.
2. The server responds with a ServerHello message, containing the chosen protocol version, a random number, CipherSuite and compression method from the choices offered by the client. If this is a new session established over the secure link then the server will send a Session ID. 3. The server sends its Certificate message 61 (depending on the selected cipher suite, this may be omitted by the server).
4. The server sends a ServerHelloDone message, indicating it is done with handshake negotiation.
5. The client responds with a ClientKeyExchange message 62, which may contain a PreMasterSecret, public key, or nothing. (Again, this depends on the selected cipher.) This PreMasterSecret is encrypted using the public key of the server certificate.
6. The client and server then use the random numbers and PreMasterSecret to compute a common secret, called the “master secret”. All other key data for this connection is derived from this master secret (and the client- and server-generated random values), which is passed through a carefully designed pseudorandom function.
7. The client now sends a ChangeCipherSpec record, essentially telling the server, “Everything I tell you from now on will be authenticated (and encrypted if encryption parameters were present in the server certificate).”
8. Finally, the client sends an authenticated and encrypted Finished message, containing a hash and MAC over the previous handshake messages.
9. The server will attempt to decrypt the client's Finished message and verify the hash and MAC. If the decryption or verification fails, the handshake is considered to have failed and the connection will be torn down.
10. Finally, the server sends a ChangeCipherSpec, telling the client, “Everything I tell you from now on will be authenticated (and encrypted, if encryption was negotiated).”
11. The server sends its authenticated and encrypted Finished message.
12. The client performs the same decryption and verification.

FIG. 4 shows, in more detail, signalling required for SSL/TLS session resumption. The client performs session resumption by announcing a session ID in the first ClientHello message 71. If the server accepts the session then steps 3, 5 and 6 of the session establishment process are omitted and the previously negotiated master secret is used to derive new key data for this connection. It can be seen that session resumption does not require the client to send the ClientKeyExchange message 62 which contains parameters used to negotiate master secret. In detail, the messages: Certificate, ServerKeyExchange, CertificateRequest, ServerHelloDone, CertificateVerify and ClientKeyExchange are not sent via the second network.

When an SSL session ends cleanly using the SSL shutdown API and both the client and the server cache the SSL information, it is possible to resume that SSL session at a later time and avoid the expense of encrypting and decrypting the secret master key portions of the SSL handshake.

To resume an SSL session over a new socket, the client includes the session ID of that particular SSL session in the CLIENT HELLO command that it sends. If the server does not have that session ID in its SSL cache, a new SSL session must be started and the normal SSL handshake flows occur. The server indicates this by creating a new session ID and returning the ID in its SERVER HELLO command.

If the server does have the requested session ID in its SSL cache, the server echoes that session ID in its SERVER HELLO command. The client and the server then create new encryption keys based on the cached parameter secret and the new random data from this SSL handshake.

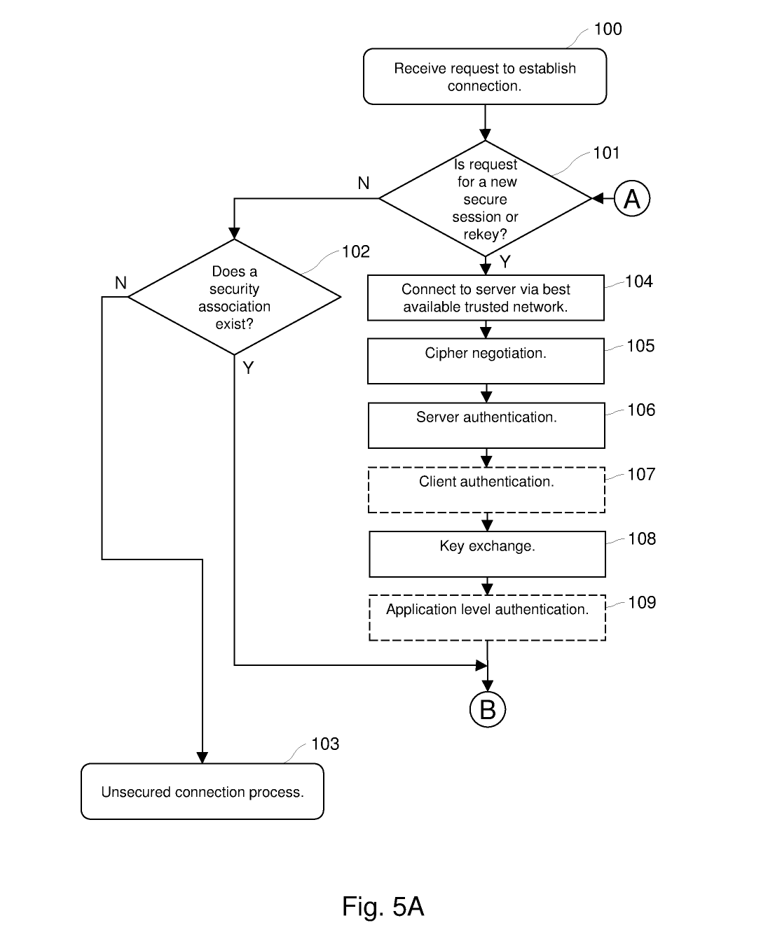

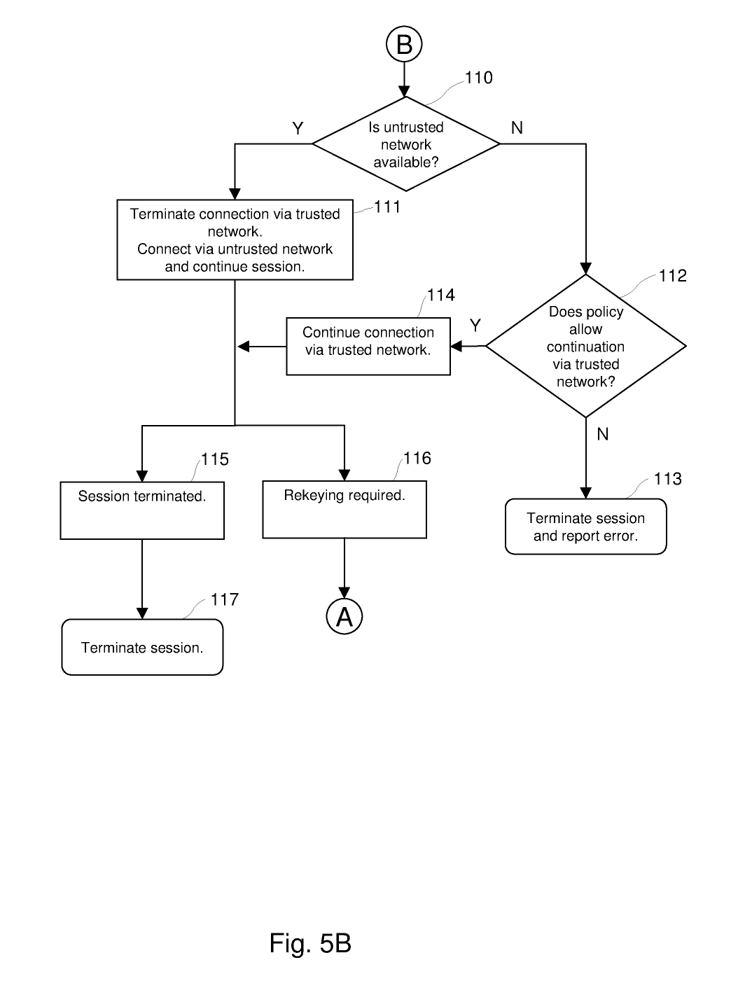

FIGS. 5A and 5B shows steps of a method performed at a client communication device. At step 100 a request is received to establish a connection. Typically, this request will originate within the client device 50, and will be caused by a need for the client device 50 to communicate within a remote endpoint. Step 101 determines if the request is for a new secure session or a rekey. A rekey is allowed by some protocols, and allows a new key to be established for an existing session, when the existing key has expired). Step 102 determines if a security association already exists. If the step 101 determines that the request is for a new secure session, the method proceeds to step 104 and connects to the server via the best available trusted network. A security association is established between the client device and server at steps 105-109. Some of steps 105-109 can be optional. Steps 104-108 can comprise part of session establishment for an SSL/TLS session. Alternatively, steps 104-108 can comprise an Internet Key Exchange (IKE) or some other Security Association conforming to the basic outline of the Internet Security Association and Key Management Protocol (ISAKMP). Cipher negotiation occurs between the endpoints at step 105. At step 106 the server is authenticated by the client device. Optionally, at step 107, the server can authenticate the client device. At step 108 the client device exchanges information used to generate a master key. Optionally, at step 109, application level authentication occurs between the end points. The client can continue to use other authentication mechanisms at this point (OTP authentication to log on to server for example). As part of steps 105-108 (e.g. in the case of an SSL/TLS session), the endpoints can establish a session ID which identifies the session.

With the security association between the endpoints now established, the method proceeds to step 110 and determines if an untrusted network is available. If an untrusted network is available, step 111 terminates the connection via the trusted network and connects via the untrusted network. This can be achieved by forcing an interruption in the session that was established via the trusted network and resuming the session via the untrusted network. The client device caches data for use by the session, such as master key information. Then the client device resumes the previously established session via the untrusted network. This can include an initial step of sending the session ID to identify the previously established session. No security information (e.g. keys, authentication credentials or cipher negotiation) needs to be sent via the untrusted network. The session via the untrusted network continues until either: the session is terminated at steps 115, 117; or rekeying is required at step 116. Rekeying is allowed by certain protocols such as IPSEC.

Returning to step 110, if an untrusted network is unavailable, the method proceeds to step 112 and determines if policy allows continuation via the trusted network. If continuation is allowed, the connection via the trusted network continues. Otherwise, the session is terminated at step 113.

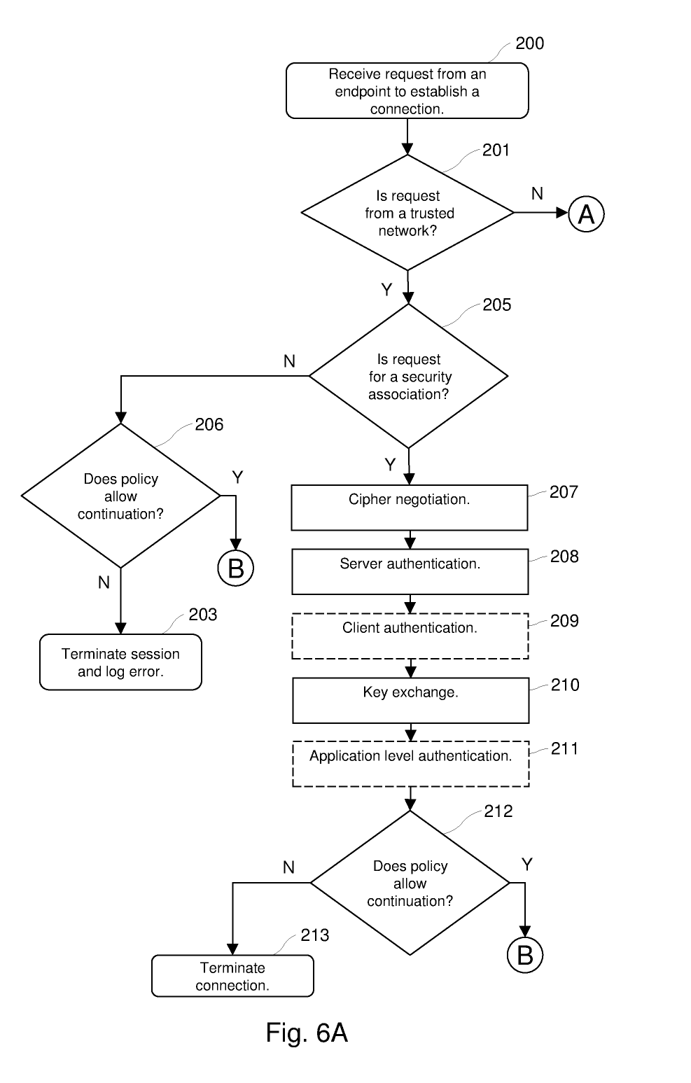

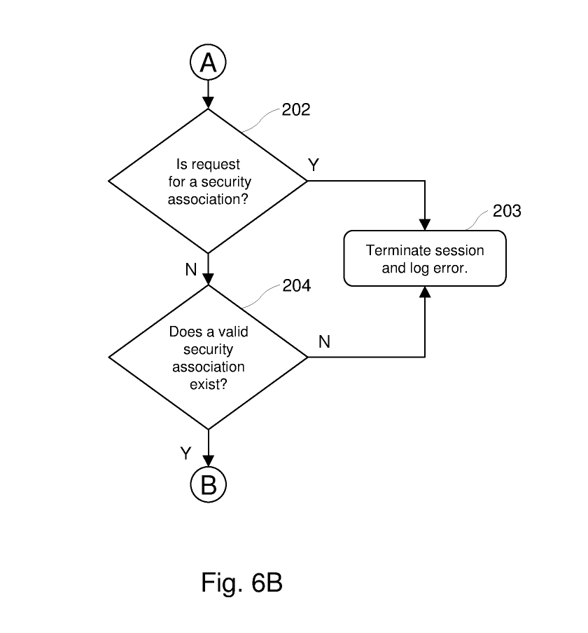

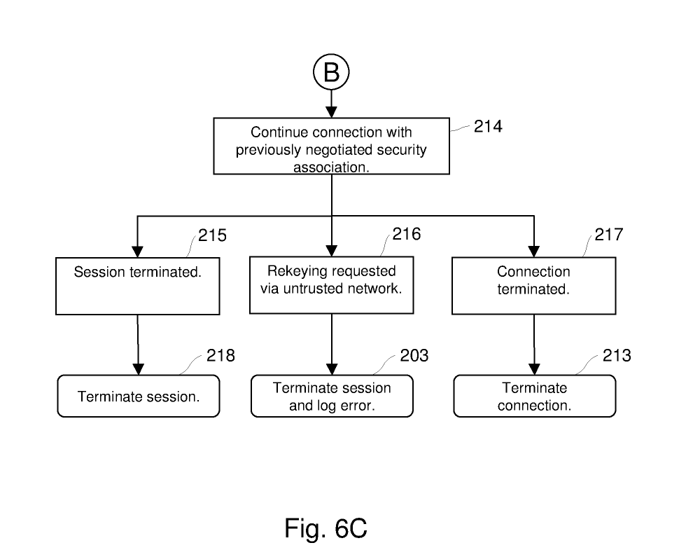

FIGS. 6A-6C shows steps of a method performed at a server. At step 200 the server receives a request from the client communication device to establish a connection via the trusted network. Step 201 determines if the request is received from a trusted network. If it is, the method proceeds to step 205 and determines if the request is for a security association. A request for a security association can comprise steps 207-211. Some of steps 207-211 can be optional. Steps 207-211 can comprise part of session establishment for an SSL/TLS session and can establish a session ID. Alternatively, steps 207-211 can comprise an Internet Key Exchange (IKE). Step 212 determines if policy allows continuation, i.e. continuing with the connection via the trusted network. If so, the method proceeds to step 214 (FIG. 6C). Otherwise, the connection is terminated at step 213.

At step 214 the connection is continued with the previously negotiated SA. The connection continues until either: the session is terminated at steps 215, 218; rekeying is requested via the untrusted network at step 216; or the connection is terminated at step 217. Rekeying (if allowed by the protocol) is only permitted via the trusted network.

If the connection via the trusted network is terminated after establishing a SA, a subsequent request to establish a connection will be received from the client device via the untrusted network at step 200. The method proceeds to FIG. 6B. Step 204 checks that a valid SA exists, and proceeds to step 214. Step 202 rejects requests for a SA via the untrusted network, and terminates at step 203.

If continuation is allowed (i.e. use of the trusted network after a SA exists), the method proceeds via steps 201, 205 and 206 to step 214 and allows the connection.

In a protocol such as SSL/TLS, where a session ID is established, step 204 can inspect the session ID and retrieve cached data corresponding to that session ID. In IPSEC, a Security Parameter Index (SPI) can be used as an index to the security association database (SADB), which identifies the SA that will be used by a particular connection. This can be combined, in some cases, with the source or destination IP addresses. In view of different routes taken by packets over the two networks, it may be necessary to ignore the IP addresses.

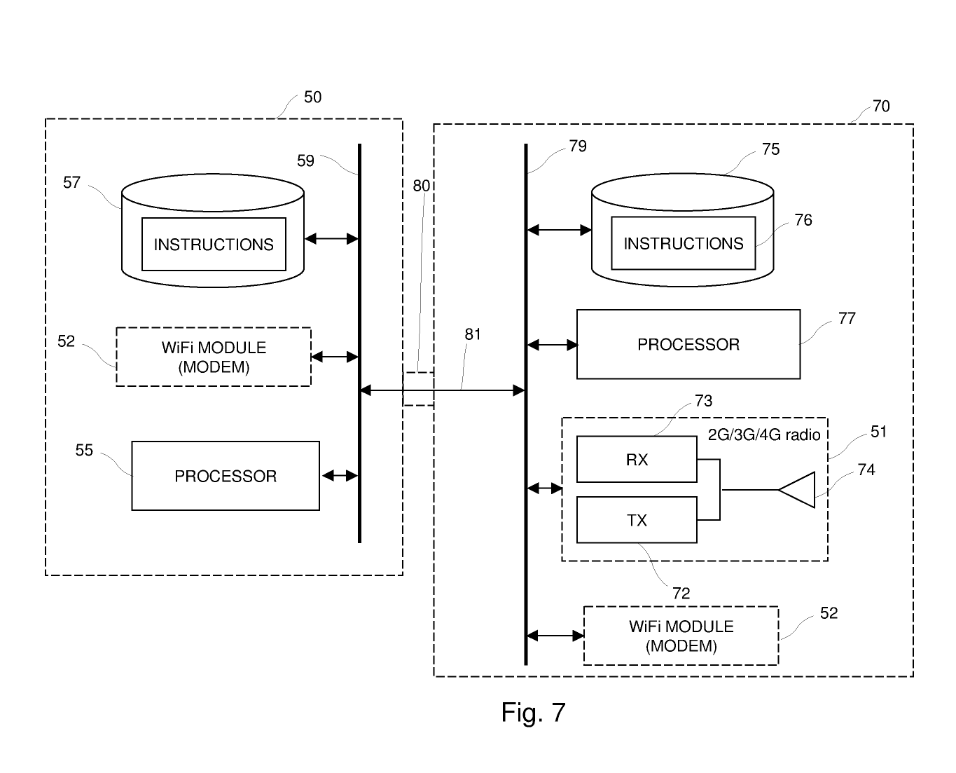

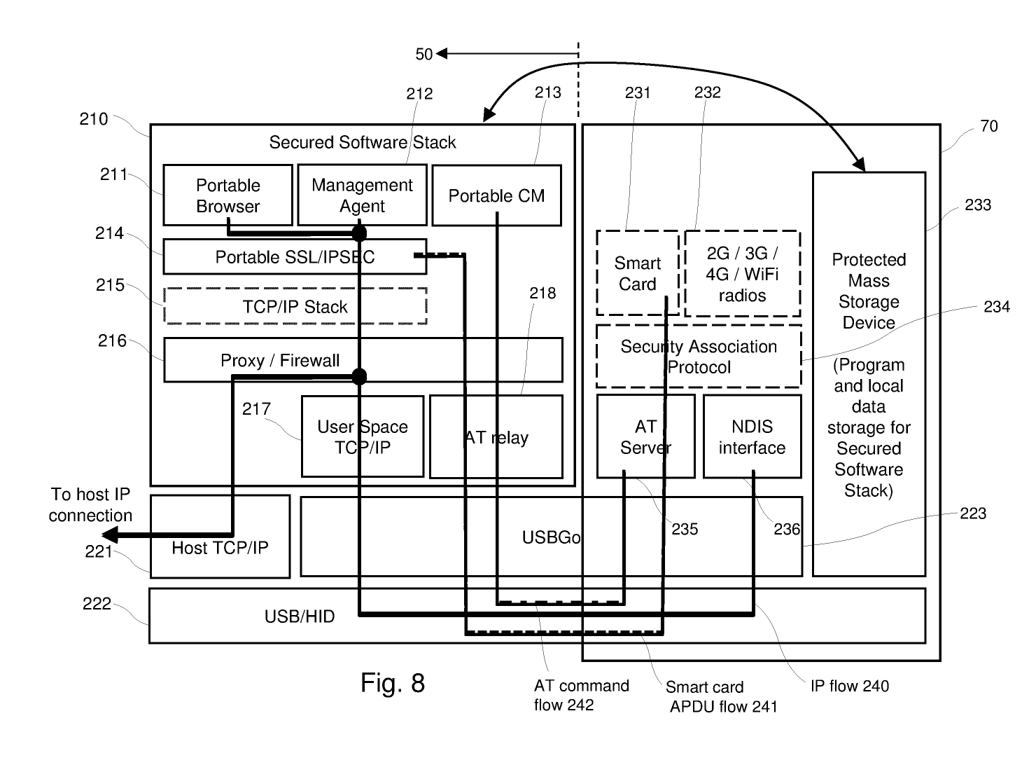

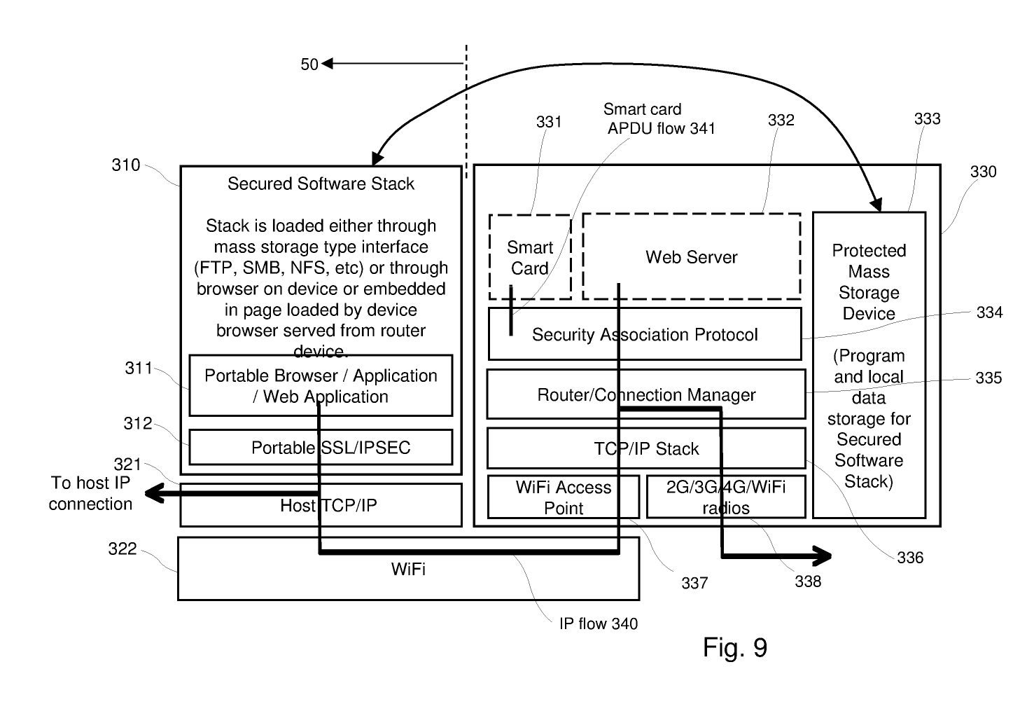

FIGS. 7 to 9 show possible embodiments of apparatus provided at a client mobile communication device. In FIGS. 7 to 9 a peripheral device 70, 330 is provided which can be connected to to a host device 50 such as a laptop or portable computer. The device shown in FIGS. 7 and 8 is often called a wireless modem device. In FIGS. 7 and 8 the peripheral device 70 can be in the form of a pluggable device, such as a USB stick, which plugs into the host device 50, and connects to the host device via USB. The peripheral device can be a plug and play device. The peripheral device does not have to physically plug into the host device and can physically stand alone from the host device and connect to it via a cable or wireless interface. In FIG. 9 a peripheral device 330 is provided in the form of a router which can connect to the host device 50 via an interface such as Ethernet of WiFi.

In FIG. 7, the peripheral device 70 comprises a communication interface for accessing the first network 20 in the form of a wireless transceiver (modem) 51, such as a GPRS/3G/4G transceiver. Transceiver 51 comprises an antenna 74, a transmit stage 72 and a receive stage 73. It will be well understood that a transceiver capable of Multiple In-Multiple Out (MIMO) communication will comprise multiple antennas 74, multiple transmitters 72 and multiple receivers 73. Peripheral device 70 can comprise a processor 77, which may be a microprocessor, controller or any other suitable type of processor for executing instructions to control the operation of the device. The processor 77 is connected to other components of the module via one or more buses 79. The processor-executable instructions 76 may be provided using any computer-readable media, such as memory 75. The memory is of any suitable type such as read-only memory (ROM), random access memory (RAM), a storage device of any type such as a magnetic or optical storage device. Additional memory can be provided to store data used by the processor 77. Peripheral device 70 comprises an interface 81, such as a Universal Serial Bus (USB) interface for interfacing with the host 50 via connector 80. The interface can be a plug and play interface.

The host device 50 comprises a processor 55, storage 57 and a communication interface for accessing the second network, such as a WiFi transceiver (modem) 52. The WiFi modem 52 may, in one embodiment, be located in the peripheral device 70. One or more buses 59 connect the processor 55 to the storage 57, module 52 and the interface 81 to the external peripheral device 70.

In an embodiment of the invention, the controlled browser 54 can be stored in protected storage 75 on the peripheral device 70. The protected storage 75 may only be able to be read by the client device or may by encrypted and unlocked using a password or Personal Identification Number (PIN) code.

The user interface of the browser are executed by processor 55. The functions of the browser may be fully implemented by processor 55, or partially implemented by processor 77. For example, the browser, SSL/TLS and IP stack may be executed fully on the main host processor 55 or some functions may be executed on processor 77. For example, the SSL/TLS session may be established on processor 77 using digital certificates stored inside a device in the peripheral device 70 such as a SIM card or SmartCard. In this case the portion of the SSL/TLS stack running on processor 55 will pass the random numbers and negotiated cipher exchanged during a session resumption over the untrusted network to processor 77 which will return an encryption key derived from the master key. In this case the master key will never leave device 70. If the untrusted network interface such as the WiFi radio is located inside the peripheral device 70 then the entire negotiation may occur inside the peripheral device 70.

The peripheral device 70 can be implemented in a manner which requires no additional driver software on the host 50. This will be referred to as “zero footprint environment”. Further details of the peripheral device, other than the novel and inventive features of the present invention, can be found in EP 2107463 which is incorporated herein by reference in its entirety and especially FIG. 1 and the associated text.

Some possible embodiments of the host 50 and the peripheral device 70 include:
a (pluggable) peripheral device 70 (e.g. USB or LGA interface) with a 2G/3G/4G modem 51, protected storage 75 and zero footprint environment;
a (pluggable) peripheral device 70 (e.g. USB or LGA interface) with a 2G/3G/4G modem 51, WiFi modem 52, protected storage 75 and zero footprint environment.
   Another possible embodiment is a software only stack on host device 50. This can use a Trusted Platform Module in the device platform itself or a micro SD card or other removable module.

FIG. 8 shows a host device and a peripheral device 70 in the form of a USB connected device, showing detail of interfaces and protocol stacks. A protected mass storage device 233 is used for protected program storage and local data storage. The protected mass storage device may have multiple partitions (Read Only, Encrypted Read/Write, Public Read/Write). Software stack 210 is loaded from storage device 233. FIG. 8 shows the devices in an operational state, with the software stack loaded into the host device memory space. The secured software stack can comprise elements 211-218:

211—browser (e.g. HTML5). Local storage requirements e.g. configuration, cookies and HTML5 local data are all stored in protected mass storage 233. Some profile information may be stored in the Smart Card 231.
212—Management agent contacts management server. Some functions of management agent may be located inside peripheral device 70.
213—Portable connection management software.
214—Portable SSL and/or IPSEC stack. Security association portions of protocols may be located here or in the peripheral device (item 234).
215—Optional TCP/IP stack. This may be necessary in some implementations where browser/agent cannot be directly connected to proxy/firewall.
216—Proxy/Firewall. Controls the routing of TCP/IP flows to networks from browser and agent.
217—Secure TCP/IP stack.
218—Relay for AT commands from connection manager 213 and Smart Card interaction from SSL/IPSEC/Browser.

Other elements provided on the host 50 can include: a TCP/IP stack 221 to access on device network connections; USB mass storage and Human Interface Device (HID) interfaces 222; a USBGo implementation 223.

Peripheral device 70 comprises the mass storage device 233 with the secured software stack. Optionally, a Smart Card 231 is contained inside device 70 (e.g. a card, embedded chip or micro SD card). This can be used for storage of profile information, storage of encryption keys and authentication/signature certificates. Part 234 of the SSL/IPSEC protocols may be implemented on device 70, such as functions associated with establishing a Security Association. This can include connection key generation inside the device 70 to minimise leakage of information necessary to establish connection outside of device 70. If module 234 is provided on the device 70, the smart card Application Protocol Data Unit (APDU) flow 241 is limited to the path between smart card 231 and module 234. A communication interface to access the first network (e.g. 2G/3G/4G wireless transceiver) can be provided here. Optionally, a communication interface to access the second network (e.g. WiFi transceiver) can be provided here. Other elements of the device 70 can comprise an AT command server 235 and a Network Data Interface Specification data interface, or other suitable data interface. IP data flows along path 240 between the NDIS interface 236 and the browser 211 (or to other IP sources in the host device).

FIG. 9 shows a host device and a peripheral device 330 in the form of a router, showing detail of interfaces and protocol stacks. Many functional modules are the same as previously described for FIG. 8. A protected mass storage device 333 is used for protected program storage and local data storage. The secured software stack 310 can be loaded as a program from storage 333 via a mass storage type interface or via web server on device 330 as a program or web page. The secured software stack 310 can comprise a portable browser 311 or application running inside a local browser and a portable SSL/IPSEC stack 312.

Other elements provided on the host 50 can include: a host TCP/IP stack 321; and an interface 322 (e.g. Ethernet, WiFi or other interface) between host 50 and peripheral device 330.

Peripheral device 330 comprises the mass storage device 333 with the secured software stack. Optionally, a Smart Card 331 is contained inside device 330 (e.g. a card, embedded chip or micro SD card). This can be used for storage of profile information, storage of encryption keys and authentication/signature certificates. Part 334 of the SSL/IPSEC protocols may be implemented on device 330, such as functions associated with establishing a Security Association. This can include connection key generation inside the device 330 to minimise leakage of information necessary to establish connection outside of device 330. The smart card Application Protocol Data Unit (APDU) flow 341 is limited to the path between smart card 331 and module 334. A communication interface 338 to access the first network (e.g. 2G/3G/4G wireless transceiver) is provided here. A communication interface 338 to access the second network (e.g. WiFi transceiver) can be provided here. Device 330 also comprises an interface to connect with host 50, such as a WiFi interface 337 shown in FIG. 9. Device 330 also comprises an IP router and connection manager for different radios/transports. IP data flows along path 340 between the browser 311 in the host and the IP router 335 in the peripheral device 330.

As described above, the peripheral device 70 can be implemented in a manner which requires no additional driver software on the host 50, which will be referred to as “zero footprint environment”. Further details of the peripheral device, other than the novel and inventive features of the present invention, can be found in EP 2107463 which is incorporated herein by reference in its entirety and especially FIG. 1 and the associated text. A summary of the zero footprint environment will now be given. Referring again to FIG. 8, the zero footprint environment comprises: a host/modem interface (“USBGo”) 223 using the USB/Human Interface Device (HID) protocol 222 to transport AT data 242 and IP data 240; an external TCP/IP stack 217 configured to send IP data through the above mentioned USB/HID channel 222; a TCP/IP proxy 216 configured to translate host TCP/IP stack 221 into external TCP/IP stack 217; a Connection Manager (CM) 213 able to open a connection through the interface provided by the proxy 216; a program launcher and portable applications, such as a web browser application 211.

An example of use case will now be described.

1. The user plugs the peripheral device 70 (also referred to as “the modem device”). At this point, the modem 70 presents itself as a USB modem with VID/PID. Additionally, this solution builds on top of one of the default (non network) USB HID device class drivers available in the most common OS (Windows XP, Vista, Mac OSX and Linux). At this point, there are two alternatives on how the OS can react. If the USB modem drivers have not been installed, the OS recognizes the device as a MSD+HID generic device (the device is configured for presenting itself this way) and therefore loads those drivers. Alternatively, the USB modem drivers might have been installed, and then these drivers will handle the device. Assuming the OS generic drivers are used, the USB modem 70 presents itself as a USB Mass Storage Device presenting a CD Rom (exposing flash memory), a Generic Volume (exposing microSD) and a 3rd Generic Device to transport control and TCP/IP data between the host OS and the USB modem 70. Immediately after this configuration is shown in the OS, and now assuming a Windows OS, the CD Rom has an autorun that launches a launcher in which the user has the possibility to launch amongst other applications a web browser (e.g. Firefox) and a Connection Manager (CM). This launcher is based on portable application principles, as it is also done with other applications.

2. The user starts the Connection Manager and starts a connection. The Connection Manager opens a serial virtual port (interface provided by a proxy running from the modem device) to be able to send AT commands and therefore opening a packet data protocol (PDP).

3. When the connection is established using AT commands, a PDP is created and the network will return a set of IP configuration parameters. These network parameters are passed to a proprietary proxy server that contains an embedded TCP/IP stack that is adapted to work with the USB HID interface to pass IP and control data. This proxy sits also on top of the standard windows sockets to be able to listen to incoming request to the localhost (see following step).

4. The user starts the web browser and opens a site (e.g. http://www.google.com). This web browser is configured to use the previously mentioned proxy on the localhost. When the proxy receives the request, it will use the second proprietary interface (with the embedded TCP/IP stack) to transmit/receive data to/from the network.

In the peripheral device, a pre-installed generic driver of an operating system installed on the computer device can be used for setting up a modem/host communication interface by means of which the peripheral device and the computer device can communicate with each other. Data traffic from the computer device towards the wireless communication network and vice versa is routed over this modem/host communication interface and uses the generic communication protocol provided by the pre-installed generic driver. This has the advantage that the need for a specific driver for the communication between the wireless modem device and the computer device can be avoided. This has the advantage that a user can use the peripheral device on a computer device on which he has no administrator rights, i.e. a computer device on which his user rights are restricted so that he cannot install a specific driver for the peripheral device, for example a computer device in a hotel, on an airport and the like.

As used herein, by “pre-installed generic driver” is intended to mean a driver which is installed on the computer device along with the installation of the operating system, i.e. a driver which is standard for the operating system and which is capable of driving a standard class of computer peripheral devices connected to the computer device without requiring installation of a specific driver for such a computer peripheral device. An example of such a generic driver is a human interface driver (HID), which has predetermined software components configured for driving a human interface device such as a mouse, a keyboard or other. Another example of such a generic driver is a mass storage device (MSD) driver, which has predetermined software components configured for driving mass storage devices such as USB memory sticks, external hard drives, or more generally readable and writable computer peripheral memory devices. HID and MSD drivers are known per se in the art an therefore need not be described in detail herein.

Advantageously, one of the pre-installed generic drivers of the operating system on the computer device is exploited for setting up the peripheral device/host communication interface, i.e. the generic driver is used in connection with a computer peripheral device for which it is not actually intended. In other words, the peripheral device of the invention does not belong to the standard class of computer peripheral devices for which the generic driver is foreseen in the operating system. Nevertheless, it has been found according to the invention that the peripheral device can communicate with the computer device by using the generic communication protocol provided by the generic driver over the modem/host communication interface. In particular, the generic communication protocol is used as the lower layer communication protocol for exchanging information between the peripheral device and the computer device, such as for example AT commands or IP data. In advantageous embodiments, the peripheral device of the invention uses a proprietary protocol stack (e.g. a proprietary TCP/IP stack) rather than a kernel protocol stack (e.g. a kernel TCP/IP stack) which is otherwise generally used by the operating system and any applications running under the operating system on the computer device for any network communication.

In advantageous embodiments, the proprietary protocol stack is preferably set up on the computer device, although in alternative embodiments the proprietary protocol stack may also be set up on the peripheral device.

In advantageous embodiments, the peripheral device of the invention uses a proxy to move data traffic from the kernel protocol stack to the proprietary protocol stack, i.e. to indicate to running applications that network communication is to be performed using the proprietary protocol stack set up by the peripheral device rather than the kernel protocol stack.

In advantageous embodiments, the peripheral device stores at least one application and is provided for launching said application as a portable application, meaning that the application keeps its data (cache) in the memory of the peripheral device and no traces are left on the computer device. The application can for example be a web browser application, e.g. a controlled browser 54 (described below) or other. The web browser application preferably has predefined settings, such that it is configured to make use of the proxy server application with embedded proprietary protocol stack for connecting to the internet.

The above mentioned features of the peripheral device and its operation method contribute to the advantage that any modification to settings in the kernel protocol stack or in the operating system can be avoided, or more in general that any traces on the computer device can be avoided, so that upon disconnecting the peripheral device from the computer device, it is as if it has never been used on the computer device. As used herein, this effect is termed a “zero footprint”, i.e. the peripheral device leaves no trace or a “zero footprint” on the computer device.

In advantageous embodiments of the peripheral device of the invention, software code portions are stored on the peripheral device or on a separate memory device (e.g. a micro SD card) connectable to the wireless modem device, which are configured for performing one or more of the above mentioned steps, i.e. the use of a pre-installed generic driver, the setting up of a proprietary protocol stack, the use of a proxy, etc. The software code portions are preferably stored in a read only partition.

FIG. 1 shows a single trusted network 20 and a single untrusted network 30. There can be multiple “trusted” networks. Similarly, there can be multiple “untrusted” networks. In the event of multiple trusted networks, the method can select one of the trusted networks which is considered to offer the highest level of trust, or can select one of the trusted networks according to some other criterion or criteria. Similarly, there can be multiple untrusted networks, such as multiple WiFi access points. In the event of multiple untrusted networks, the method can select one of the untrusted networks which is considered to offer the highest level of trust, or can select one of the untrusted networks according to some other criterion or criteria, such as data throughput or cost.

An initiative called DNS-based Authentication of Named Entities (DANE) allows a domain to publish the root certificate that should be used to verify sites under it (DANE DNS-based Authentication of Named Entities). While this would allow domains to constrain the certificates used to authenticate hosts under them, this assumes that the DNS itself is not open to attack. Unfortunately, this is not the case. There are extensions proposed to DNS, known as Domain Name System Security Extensions (DNSSEC), which would allow DNS servers to prove their authority over a domain (DNSSEC). This assumes that the entity managing the DNS infrastructure, which is generally a Non-Governmental Organisation (NGO) or government, is not itself attackable or interested in attacking.

Referring to FIG. 1, a further improvement is for the corporate network 40 of Company1 to provide a stronger DNS server 43 implementing Domain Name System Security Extensions (DNSSEC) and DNS-based Authentication of Named Entities (DANE). This can be achieved without the issues associated with deploying DANE/DNSSEC on the public internet. In this case, the root certificate used to verify the HTTPS server 42 can be provided by Company1. This certificate could either be signed by a known Certificate Authority (CA) or could be self-signed.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1-23. (canceled)

24. A method of establishing a secure communication session between a first endpoint and a second endpoint, wherein the first endpoint can contact the second endpoint via a first communication network and via a second communication network, wherein the first communication network is more trusted than the second communication network, the method comprising, at the first endpoint:
determining that the secure communication session is required;
establishing a security association with the second endpoint for the communication session on a connection via the first communication network; and
receiving service, provided by the second endpoint, on a connection via the second communication network using the previously established security association;
wherein
the step of establishing the security association occurs as part of a step of establishing the secure communication session via said first communication network;
the first endpoint forces an interruption in the established secure communication session via said first communication network after security association has been established;
the step of establishing the secure communication session via said first communication network further comprises determining a session identifier;
the step of receiving service on the connection via the second communication network resumes the previously secure established communication session using the session identifier;
wherein the first endpoint forces the step of establishing the security association with the second endpoint to occur via the first communication network, and prevents the step of establishing the security association with the second endpoint from occurring via the second communication network.

25. A method according to claim 24, wherein the step of establishing the security association comprises authenticating the second endpoint and negotiating ciphers to be used between the first and second endpoint and securely exchanging a shared secret and wherein, the step of receiving service on the connection via the second communication network occurs without any further negotiation of key material, ciphers or authentication between the first and second endpoint via the second communication network.

26. A method according to claim 24 wherein the step of establishing the security association comprises authenticating the second endpoint.

27. A method according to claim 24 wherein the step of establishing the security association further comprises receiving a request from the second endpoint to authenticate the first endpoint.

28. A method according to claim 24 wherein the first endpoint is a communication device comprising a module for accessing the first communication network, and the step of establishing the security association is performed by the module for accessing the first communication network.

29. A method of establishing a secure communication session between a first endpoint and a second endpoint, wherein the first endpoint can contact the second endpoint via a first communication network and via a second communication network, wherein the first communication network is more trusted than the second communication network, the method further comprising, at the second endpoint:
receiving a request to establish the security association with the first endpoint for the secure communication session;
establishing the security association between the first and second endpoint for the secure communication session on the connection via the first communication network; and
providing service, to the first endpoint, on the connection via the second communication network using the previously established security association;
wherein
the step of establishing the security association with the first endpoint occurs as part of the step of establishing the secure communication session via said first communication network and further comprises determining the session identifier, and
the step of providing service on the connection via the second communication network resumes the previously established secure communication session using the session identifier.

30. A method according to claim 29 wherein the second endpoint prevents the step of establishing a security association between the first and second endpoint from occurring via the second communication network.

31. A method according to claim 29 wherein the step of establishing the security association comprises negotiating the shared key material and wherein, the step of providing service on the connection via the second communication network occurs without any further negotiation of key material between the first and second endpoint via the second communication network.

32. A method according to claim 29 wherein the step of establishing the security association with the first endpoint further comprises authenticating the communication device.

33. A method according to claim 29 wherein the secure communication session is one of: a Secure Sockets Layer/Transport Layer Security (SSL/TLS) session; and an Internet Protocol Security (IPSEC) session.

34. A module such as a peripheral device suitable for connection to a host computer device and for establishing a secure communication session between the host computer device and an endpoint, wherein the host computer device can contact the endpoint via a first communication network and via a second communication network, wherein the first communication network is more trusted than the second communication network, the module comprising:
a memory; and
computer executable code stored in the memory adapted to perform the steps of claim 24.

35. A module according to claim 34 further comprising at least one of:
a first communication interface for accessing the first network;
a second communication interface for accessing the second network.

36. A module according to claim 34 wherein the memory is read only and/or encrypted.

37. A module according to claim 34 comprising:
a first communication interface for accessing the first network; and
a processor;
wherein the processor is arranged to execute the code portion for establishing the security association between the host computer device and the endpoint for the secure communication session on the connection via the first communication network.

38. A module according to claim 34 wherein the module is adapted to store at least one application and is adapted to launch the application as a portable application.

39. A module according to claim 38 wherein the application is a browser.

40. A module according to claim 34 in the form of a peripheral device and further comprising an interface for connecting to the host computer device.

41. A computer device comprising a module according to claim 34.

42. A computer program product comprising a machine-readable medium carrying instructions which, when executed by a processor, cause the processor to perform the steps of claim 24 to establish a secure communication session between a host computer device and an endpoint, wherein the host computer device can contact the endpoint via a first communication network and via a second communication network, wherein the first communication network is more trusted than the second communication network.

43. A method according to claim 28 wherein the step of establishing the security association with the first endpoint further comprises authenticating the communication device.
